(19) United States
(12) Patent Application Publication
(10) Pub. No.: US 2014/0291477 A1
(43) Pub. Date: Oct. 2, 2014

(54) SUPPORTING APPARATUS FOR MONITOR

(71) Applicant: HON HAI PRECISION INDUSTRY CO., LTD., New Taipei (TW)

(72) Inventor: FU-KUO HUANG, New Taipei (TW)

(73) Assignee: HON HAI PRECISION INDUSTRY CO., LTD., New Taipei (TW)

(21) Appl. No.: 14/093,116

(22) Filed: Nov. 29, 2013

(30) Foreign Application Priority Data
Apr. 2, 2013 (TW) 102111986

(51) Int. Cl. G06F 1/16

(52) U.S. Cl. CPC G06F 1/1601
USPC 248/688

(57) ABSTRACT

A supporting apparatus includes a protective enclosure configured to receive a monitor, a stand secured to the protective enclosure, and a latching structure rotatably secured to the stand. The stand is rotatable relative to the protective enclosure between a first position and a second position. When the stand is in the first position, the latching structure is engaged with the protective enclosure, and the stand is received in the protective enclosure. When the stand is in the second position, the latching structure is disengaged from the protective enclosure, and the stand supports the protective enclosure.

### BACKGROUND

1. Technical Field

The present disclosure relates to supporting apparatuses, and more particularly to a supporting apparatus for a monitor.

2. Description of Related Art

A stand is used to support a monitor, but the stand is separate from the monitor. To use the monitor, the stand needs to be attached to the monitor to support the monitor. When the monitor is not in use, the stand needs to be detached from the monitor. However, it is very inconvenient to attach and detach the stand from the monitor. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a supporting apparatus and a monitor.

FIG. 2 is similar to FIG. 1, but viewed from a different aspect.

FIG. 3 is an assembled view of FIG. 1, wherein the stand is in a first position, and a blocking tab blocks a rotating piece.

FIG. 4 is similar to FIG. 3, but the rotating piece is disengaged from the blocking tab.

FIG. 5 is an assembled view of FIG. 1, wherein the stand is in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

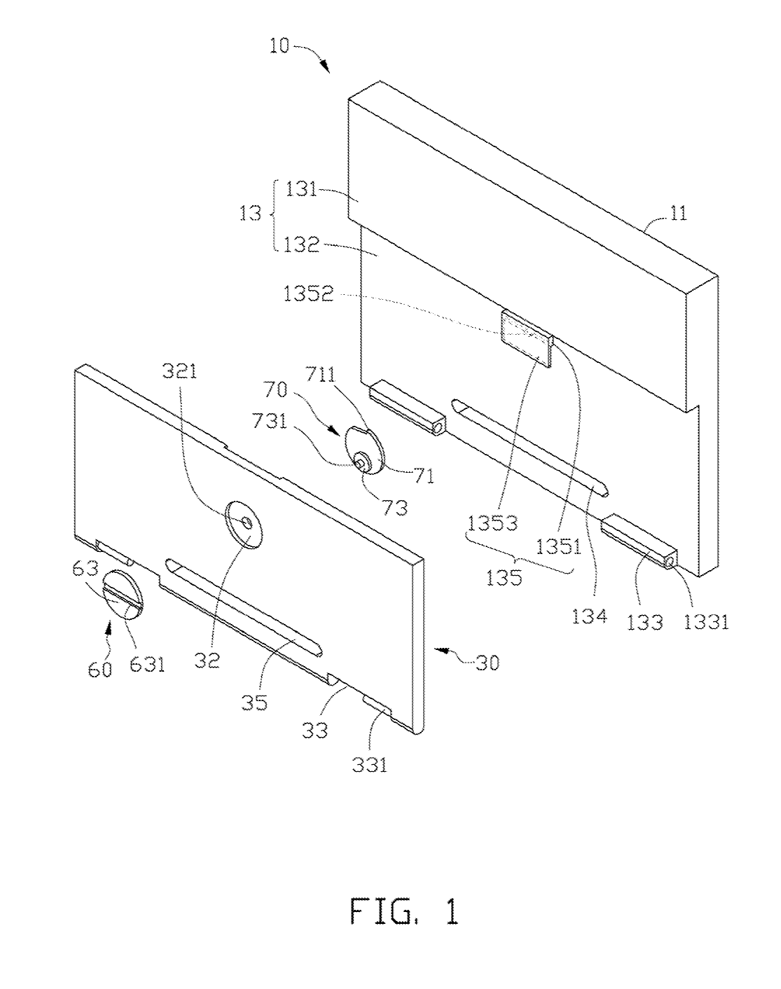

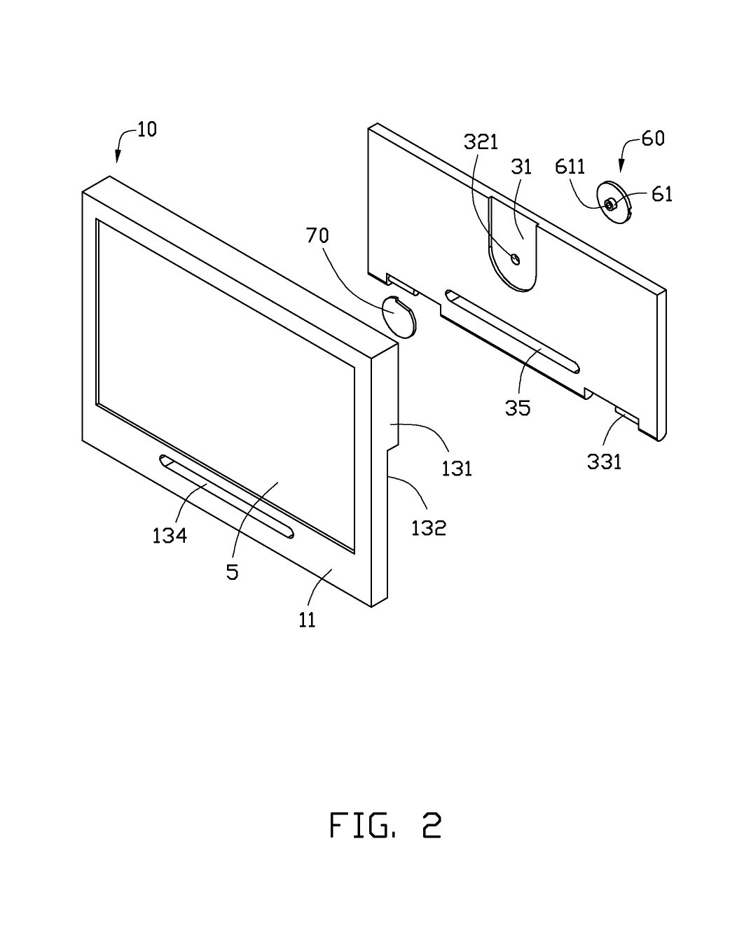

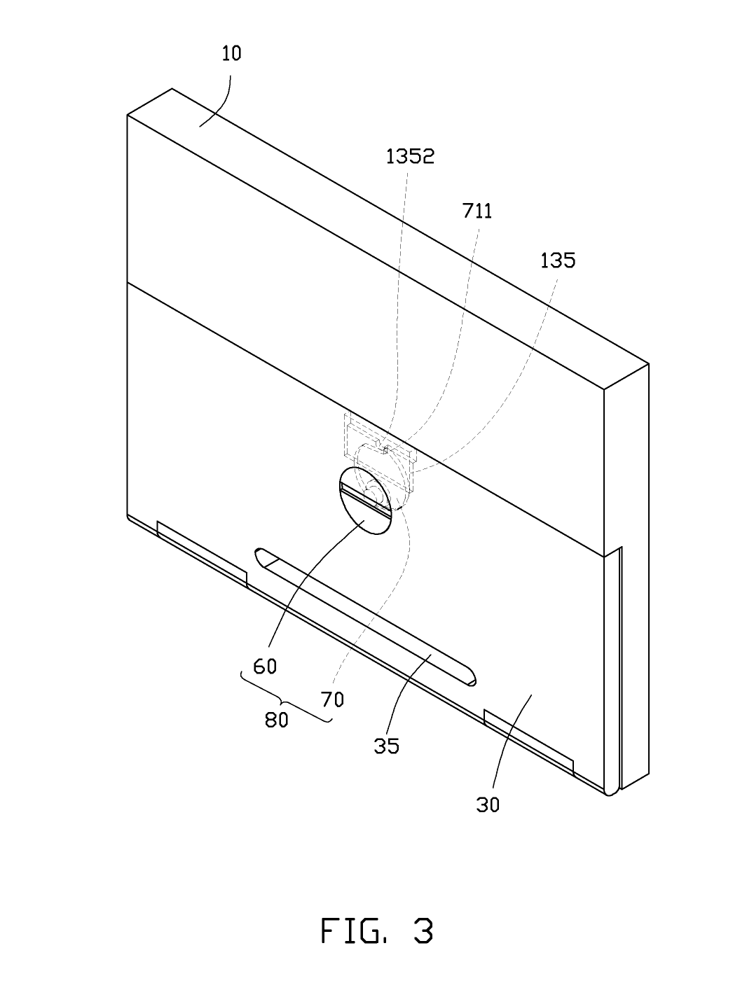

FIGS. 1-2 illustrate an embodiment of a supporting apparatus configured to support a monitor 5. The supporting apparatus includes a protective enclosure 10, a stand 30, and a latching structure 80 (shown in FIG. 3) rotatably secured to the stand 30. In one embodiment, the supporting apparatus is a notebook computer enclosure.

The protective enclosure 10 includes a front portion 11 and a back portion 13. The back portion 13 includes a protruding portion 131 and a recess portion 132. The recess portion 132 receives the stand 30. Two securing strips 133 are located adjacent to a bottom edge of the recess portion 132. The two securing strips 133 are collinear with each other, and each securing strip 133 defines a pivot hole 1331. The recess portion 132 defines a first elongated hole 134 defined through the front portion 11. The first elongated hole 134 is defined above the two securing strips 133. A blocking portion 135 is located in the recess portion 132 and includes a connecting portion 1351 and a blocking piece 1353. The connecting portion 1351 is connected to a wall of the recess portion 132, and the blocking piece 1353 extends downwards from the connecting portion 1351. In one embodiment, the blocking piece 1353 is substantially parallel to the wall of the recess portion 132, and a space 1354 is defined between the blocking piece 1353 and the wall of the recess portion 132. A blocking tab 1352 extends from the connecting portion 1351 and positioned between the blocking piece 1353 and the recess portion 132. The blocking tab 1352 is semicircle.

The stand 30 defines a receiving slot 31 in a first side surface thereof facing the protective enclosure 10. The receiving slot 31 is configured to receive the blocking portion 135. The stand 30 further defines an installation slot 32 in a second side surface thereof. A through hole 321 is defined through the installation slot 32 and the receiving slot 31. The stand 30 defines two cutouts 33 in a bottom portion thereof. A second elongated hole 35 corresponding to the first elongated hole 134 is defined in the stand 30, so that the monitor 5 can be conveniently carried via the first elongated hole 134 and the second elongated hole 35. A pivot shaft 331 extends from one sidewall of a corresponding cutout 33. Each pivot shaft 331 is rotatably received in a corresponding pivot hole 1331 of the two securing strips 133.

The latching structure 80 includes an actuating member 60 located on the stand 30, and a rotating member 70 connected to the actuating member 60. The actuating member 60 includes an actuating piece 63 and a screw post 61 protruding from a first surface of the actuating piece 63. A second surface of the actuating piece 63 defines an accommodation slot 631. The screw post 61 defines a screw hole 611. The screw hole 611 forms a plurality of inner threads.

The rotating member 70 includes a rotating piece 71 and a gasket 73. A latching tab 711 protrudes from the rotating piece 71. In one embodiment, the rotating piece 71 is substantially circular and has a first center point, and the gasket 73 is substantially circular and has a second center point that is not aligned with the first center point. A positioning post 731 protrudes from the gasket 73. A plurality of outer threads (not shown) is formed on the positioning post 731.

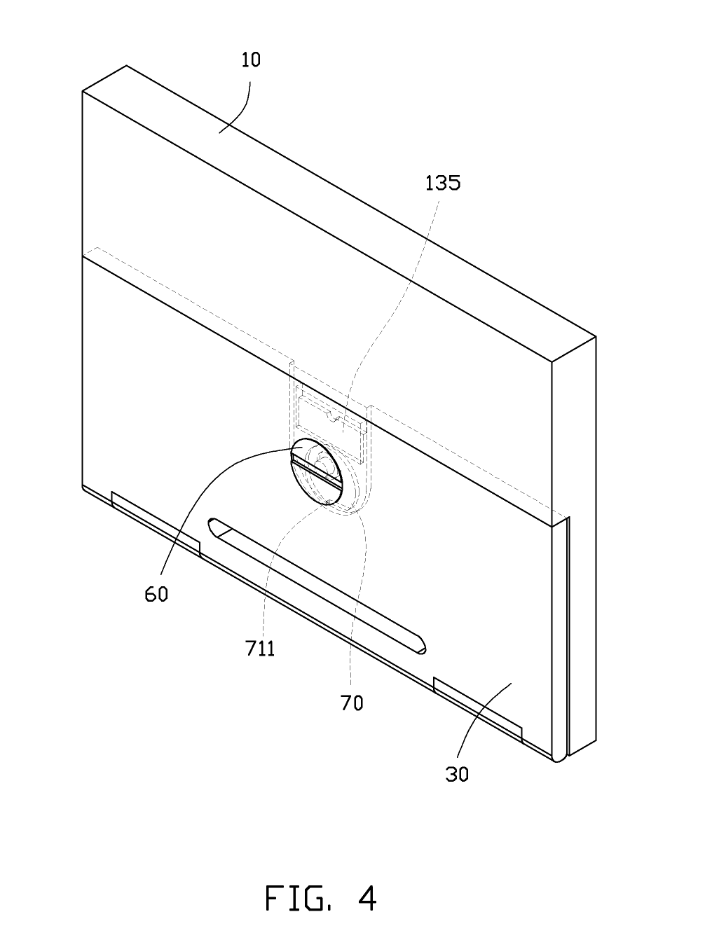

Referring to FIGS. 3-4, in assembly of the actuating member 60, the screw post 61 is received into the through hole 321, and the actuating piece 63 is received in the installation slot 32. The positioning post 731 is rotatably received into the screw hole 611, and the gasket 73 of the rotating member 70 is received in the receiving slot 31. The rotating piece 71 is exposed out of the stand 30.

In assembly of the stand 30 and the latching structure 80, each pivot shaft 331 of the stand 30 is received in a corresponding pivot hole 1331 of the protective enclosure 10, so that the stand 30 is secured to the protective enclosure 10.

FIGS. 3-4 show the stand 30 in a first position, wherein the stand 30 is received in the recess portion 132 of the protective enclosure 10. The actuating piece 63 of the actuating member 60 is rotated relative to the stand 30 to rotate the rotating piece 71, until the blocking tab 1352 blocks the latching tab 711 to prevent the rotating piece 71 from rotating further. Thus, the rotating piece 71 is partially received in the space 1354 to prevent the stand 30 from rotating relative to the protective enclosure 10. The first elongated hole 134 is aligned with the second elongated hole 35, so that the monitor 5 can be carried via the first elongated hole 134 and the second elongated hole 35.

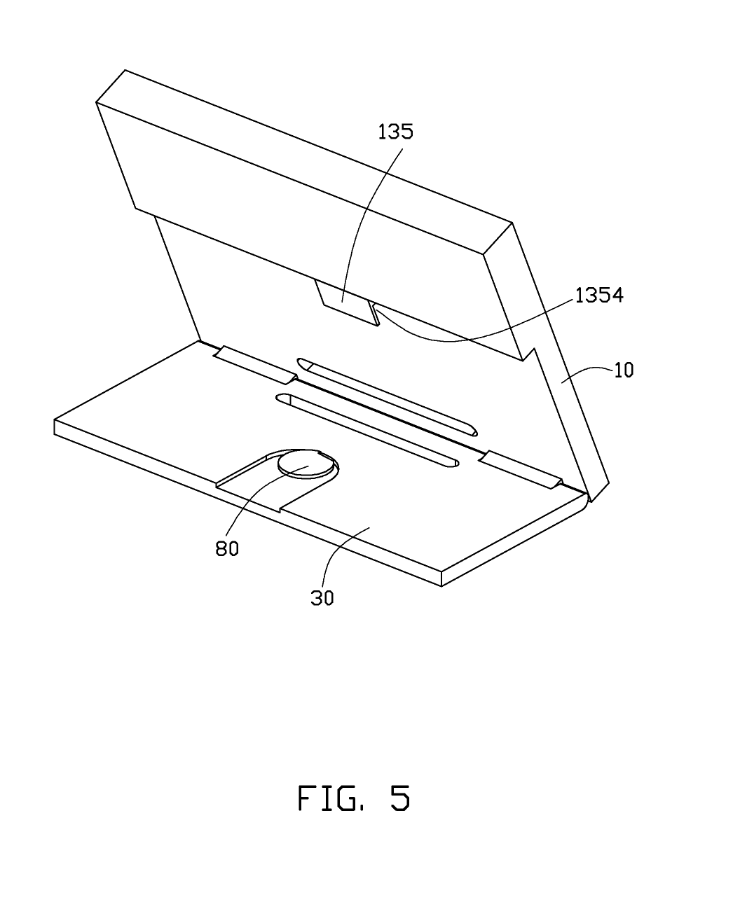

FIG. 5 shows that when the stand 30 needs to be used, the actuating piece 63 is rotated to rotate the latching tab 711 away from the blocking tab 1352, and the rotating piece 71 away from the blocking piece 1353. The stand 30 is rotated to be in a second position, wherein the stand 30 supports the protective enclosure 10 and the monitor 5, and an acute angle is defined between the stand 30 and the protective enclosure 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A supporting apparatus, comprising:
a protective enclosure configured to receive a monitor;
a stand secured to the protective enclosure; and
a latching structure rotatably secured to the stand;
wherein the stand is rotatable relative to the protective enclosure between a first position and a second position; when the stand is located in the first position, the latching structure is engaged with the protective enclosure, and the stand is received in the protective enclosure; and when the stand is located in the second position, the latching structure is disengaged from the protective enclosure, and the stand supports the protective enclosure.

2. The supporting apparatus of claim 1, wherein the latching structure comprises a rotating member, and the protective enclosure comprises a blocking portion; when the stand is located in the first position, the rotating member is engaged with the blocking portion; when the stand is located in the second position, and the rotating member is disengaged from the blocking portion.

3. The supporting apparatus of claim 2, wherein the blocking portion comprises a blocking piece, and a blocking tab connected to the blocking piece; the rotating member comprises a rotating piece and a latching tab extending from the rotating piece; when the stand is located in the first position, the blocking tab blocks the latching tab, and the blocking piece blocks the rotating piece; when the stand is located in the second position, the latching tab is disengaged from the blocking tab, and the rotating piece is disengaged from the blocking piece.

4. The supporting apparatus of claim 3, wherein the latching structure further comprises an actuating member engaged with the rotating member, and the actuating member is received in the stand and rotatable relative to the stand to rotate the rotating member.

5. The supporting apparatus of claim 4, wherein the actuating member comprises a screw post, the latching structure comprises a positioning post, the stand defines a through hole, the screw post is received in the through hole, and the positioning post is engaged with in the screw post.

6. The supporting apparatus of claim 5, wherein the actuating member further comprises an actuating piece, the rotating member further comprises a gasket located on the rotating piece, the stand defines a receiving slot and an accommodation slot opposite to the receiving slot, the actuating piece is received in the accommodation slot, and the gasket is received in the receiving slot.

7. The supporting apparatus of claim 6, wherein the through hole is in communication with the receiving slot and the accommodation slot.

8. The supporting apparatus of claim 6, wherein the rotating piece is substantially circular contour and has a first center point, the gasket is circular and has a second center point, and the first center point is not coincidence with the first center point.

9. The supporting apparatus of claim 1, wherein the protective enclosure defines first elongated hole, and the stand defines a second elongated hole corresponding to the first elongated hole; and when the stand is located in the first position, the first elongated hole is aligned with the second elongated hole.

10. The supporting apparatus of claim 3, wherein the latching tab is semicircle.

11. A supporting apparatus, comprising:
a protective enclosure configured to receive a monitor;
a stand secured to the protective enclosure; and
a latching structure rotatably secured to the stand,
wherein the stand is located in a first position, where is received in the protective enclosure, and the latching structure is engaged with the protective enclosure, to prevent the stand from rotating relative to the protective enclosure; and the stand is rotatable relative to the protective enclosure to a second position where the stand supports the protective enclosure when the latching structure is disengaged from the protective enclosure.

12. The supporting apparatus of claim 11, wherein the latching structure comprises a rotating member, and the protective enclosure comprises a blocking portion; when the stand is located in the first position, the rotating member is engaged with the blocking portion; when the stand is located in the second position, and the rotating member is disengaged from the blocking portion.

13. The supporting apparatus of claim 12, wherein the blocking portion comprises a blocking piece, and a blocking tab connected to the blocking piece; the rotating member comprises a rotating piece, and a latching tab extending from the rotating piece; when the stand is located in the first position, the blocking tab blocks the latching tab, and the blocking piece blocks the rotating piece; when the stand is located in the second position, the latching tab is disengaged from the blocking tab, and the rotating piece is disengaged from the blocking piece.

14. The supporting apparatus of claim 13, wherein the latching tab is semicircle.

15. The supporting apparatus of claim 13, wherein the latching structure further comprises an actuating member engaged with the rotating member, the actuating member is received in the stand and rotatable relative to the stand to rotate the rotating member.

16. The supporting apparatus of claim 15, wherein the actuating member comprises a screw post, the latching structure comprises a positioning post, and the stand defines a through hole, and the screw post is received in the through hole, and the positioning post is received in the screw post.

17. The supporting apparatus of claim 16, wherein the actuating member further comprises an actuating piece, the rotating member further comprises a gasket located on the rotating piece, the stand defines a receiving slot and an accommodation slot opposite to the receiving slot, the actuating piece is received in the accommodation slot, and the gasket is received in the receiving slot.

18. The supporting apparatus of claim 17, wherein the through hole is in communication with the receiving slot and the accommodation slot.

19. The supporting apparatus of claim 17, wherein the rotating piece is substantially circular contour and has a first center point, the gasket is circular and has a second center point, and the first center point is not coincidence with the first center point.

20. The supporting apparatus of claim 11, wherein the protective enclosure defines first elongated hole, and the stand defines a second elongated hole corresponding to the first elongated hole; and when the stand is located in the first position, and the first elongated hole is aligned with the second elongated hole.
